(19) United States
(12) Patent Application Publication
(10) Pub. No.: US 2023/0002680 A1
(43) Pub. Date: Jan. 5, 2023

(54) METHOD FOR MANUFACTURING HIGH YIELD MESOPHASE PITCH AND HIGH YIELD MESOPHASE PITCH MANUFACTURED THEREFROM

(71) Applicant: KOREA RESEARCH INSTITUTE OF CHEMICAL TECHNOLOGY, Daejeon (KR)

(72) Inventors: Young-Pyo JEON, Daejeon (KR); Seung Jae HA, Daejeon (KR); Min Seong JO, Daejeon (KR); Hyunsig KIL, Daejeon (KR); Hyo Cheol LEE, Daejeon (KR); Seung Hyun KO, Daejeon (KR)

(21) Appl. No.: 17/664,301

(22) Filed: May 20, 2022

(30) Foreign Application Priority Data
Jul. 1, 2021 (KR) 10-2021-0086298

(51) Int. Cl. C10C 3/08; C10C 3/00; C10C 3/02

(52) U.S. Cl. CPC C10C 3/08; C10C 3/002; C10C 3/026

(57) ABSTRACT

Provided are a method for manufacturing a high yield and high performance mesophase pitch and a high yield and high performance mesophase pitch manufactured therefrom by hydrogenating, mesophase formation, thin film evaporation, solvent-extracting, filtering and then drying to obtain only mesogen components in flow-domained mesophase pitch and then mixing the mesogen components with an isotropic pitch as a solvent component. Further, the high yield mesophase pitch of the present disclosure exhibits high spinnability while maintaining whole anisotropy and exhibits a much higher production yield than existing mesophase pitches.

### CROSS-REFERENCE TO RELATED APPLICATIONS

This application claims the priority of Korean Patent Application No. 10-2021-0086298 filed on Jul. 1, 2021, in the Korean Intellectual Property Office, the disclosure of which is incorporated herein by reference.

### FIELD OF THE INVENTION

The present disclosure relates to a method for manufacturing a high yield mesophase pitch and a high yield mesophase pitch manufactured therefrom capable of producing a mesophase pitch comprising a mesogen component and an isotropic pitch in a high yield, and the mesophase pitch exhibits liquid crystalline properties as the mesogen component and the isotropic pitch are dissolved to each other when the mesogen component is mixed with the isotropic pitch which is a solvent component.

### BACKGROUND OF THE INVENTION

Mesophase pitch or anisotropic pitch has been used as a precursor of high value-added carbon materials, such as pitch-based carbon fibers and a high quality graphite anode for LIB.

In general, a manufacturing method for the mesophase pitch is a method in which a primary purified raw material is highly hydrogenated and then polymerized at 300 to 500° C. using heat and a catalyst. until 100% anisotropy appears, and highly purified at a high level.

By such a manufacturing method, finally, mesophase pitch is manufactured at a low manufacturing yield of about 5% compared to a raw material in the case of a coal-based material and 8 to 10% compared to a raw material in the case of a petroleum-based material.

In addition, as a typical manufacturing technology for mesophase pitch, there are three types as follows.

First, a nitrogen fractionation method developed by UCC (Union Carbide Corp.) in the U.S. is used to purify the raw material at a high level in order to prevent strength deterioration due to catalytic gasification during a high-temperature heat treatment process to manufacture the mesophase pitch by thermal polymerization, but failed in mass production due to a decrease in yield.

Second, although it was successful that a high-purity mesophase pitch was produced with a relatively high yield by using pure naphthalene as a raw material and volatile fluorine (HF/BF₃) as a catalyst, an AR mesophase pitch proposed by Mitsubishi Gas chemical in Japan was impossible in low-price production and abandoned in commercialization due to a problem of a catalyst and a reactor that had to maintain 100% recycling of the manufacturing catalyst.

Third, in the 1990s, Professor Edie of Clemson University in the United States also succeeded in manufacturing mesophase pitch with a high yield compared to raw materials by supercritical fluid extraction using toluene of FCC-DO, but failed in the commercialization of the technology due to a low spinning problem of the manufactured mesophase pitch.

As such, in the related art, it was necessary to purify impurities with high purity to increase spinnability for manufacturing fibers, and as a result, due to the extremely low yield of less than 10% compared to the raw material and the resulting price problem, it was not successful in mass production, such as failing to be applied to the early industry.

As such, mesophase pitch for manufacturing high value-added carbon materials such as pitch-based carbon fibers or a graphite anode has always a trade-off problem between maintaining high spinnability and an extremely low yield due to excessive refinement for maintaining the high spinnability. Accordingly, the pitch-based carbon fibers have been developed and commercialized with a focus on extremely expensive product groups.

As pointed out, a clear theoretically concept of mesophase pitch has not been established previously. However the present applicants proposed an innovative theory of classifying a mesophase pitch as a homogeneous mixture between a mesogen component and a solvent component that expresses liquid crystalline properties by dissolving the mesogen component.

Based on the new theoretical concept described above, the present applicants developed a method of manufacturing a high yield mesophase pitch showing liquid crystalline characteristics as the mesogen and isotropic components, a solvent component, are dissolved to each other, and a high yield mesophase pitch manufactured therefrom.

At this time, the present applicants obtained a processing technique capable of securing high economic efficiency by remarkably increasing a manufacturing yield of mesophase pitch with high spinnability while maintaining whole anisotropy to 10 to 40 from 4 to 8% in the background art, by defining soluble mesophase pitch as a mixture of a lyotropic liquid crystalline material stacked by forming a liquid crystal phase and a solvent material, and completed the present disclosure.

At this time, the present applicant defined the soluble mesophase pitch as a mixture of a lyotropic liquid crystalline material and a solvent material that are stacked by forming a liquid crystal phase. Through the present invention, the applicant successfully increased the pitch yield from 4 to 8% to 10 to 40% while maintaining high spinnability and whole anisotropy, thereby completing an integrated process technology that can secure high economic feasibility compared to existing technologies.

### SUMMARY OF THE INVENTION

An objective of the present disclosure is to provide a method for manufacturing a high yield mesophase pitch capable of obtaining high economic efficiency by increasing the production yield of a mesophase pitch by manufacturing a soluble mesophase pitch which a lyotropic liquid crystalline material of anisotropic mesogen and an isotropic pitch acting as a solvent are mixed, unlike existing techniques that had a problem in an extremely low yield and low economic efficiency by performing excessive hydrogenation and removal of impurities, in order to maintain high spinnability of a fiber manufacturing process and superior physical properties after heat treatment.

Another objective of the present disclosure is to provide a high yield mesophase pitch that can be applied to high-priced carbon fiber production, low-cost carbon fiber production, artificial graphite anode materials, and the like.

Yet another objective of the present disclosure is to provide a high yield mesophase pitch with high spinnability while maintaining whole anisotropy as soluble mesophase pitch, which is a mixture of a lyotropic liquid crystalline material of anisotropic mesogen and isotropic pitch acting as a solvent.

The objectives of the present disclosure are not limited to the aforementioned objective, and other objectives, which are not mentioned above, will be apparent to those skilled in the art from the following description.

To solve the problems, according to an aspect of the present disclosure, there is provided a method for manufacturing a high yield mesophase pitch comprising a mesogen component and an isotropic pitch, which exhibits liquid crystalline properties when the mesogen component is mixed with the isotropic pitch acting as a solvent and dissolved with each other, the manufacturing method comprising the steps of:

obtaining a hydrogenated raw material by hydrogenating heavy oil;

obtaining mesophase pitch having many mesogen components by mesophase formation of the obtained hydrogenated raw material;

obtaining flow-domained mesophase pitch by removing low boiling point components through thin film evaporation of the obtained mesophase pitch and concentrating the mesogen components;

separating only the mesogen components in the flow-domained mesophase pitch by solvent-extracting, filtering, and drying the flow-domained mesophase pitch; and

mixing the separated mesogen components with isotropic pitch.

A mesophase pitch production yield of the method for manufacturing the high yield mesophase pitch may be 10% to 40%.

The isotropic pitch may be prepared by the steps of

preparing isotropic pitch by thermal-polymerizing the heavy oil at atmospheric pressure and pressurization;

controlling softening point by thin film-evaporation of the isotropic pitch at a low temperature; and

separating the softening point-controlled isotropic pitch as a solvent component.

The hydrogenating may be performed under conditions of

a reaction temperature of 350° C. to 500° C.;

a reaction time of 10 minutes to 10 hours; or

a mixing ratio (weight ratio) of heavy oil:organic solvent=1:0.5 to 1:4.

The organic solvent may include a hydrogen-donating solvent including tetralin or tetrahydroquinoline.

The mesophase polymerization may be performed under conditions of

a reaction temperature of 370° C. to 500° C.;

a reaction time of 10 minutes to 10 hours; or

an inert gas flow rate of 100 ml/min/kg to 5000 ml/min/kg.

The thin film evaporation may be performed under conditions of

a treatment temperature of 250° C. to 430° C.;

a treatment time of 5 minutes to 60 minutes; or

a pressure of 1 hPa to 100 hPa.

The flow-domained mesophase pitch obtained from the thin film evaporation may have a softening point of 240° C. to 350° C. or an anisotropic content of 90% to 100%.

The solvent extraction may be performed under conditions of

a mixing ratio (weight ratio) of flow-domained mesophase pitch:solvent=1:2 to 1:40;

an extraction time of 5 minutes to 24 hours; or

an extraction solvent, tetrahydrofuran (THF).

The solvent-extracted mesogen content may obtain 50% to 80% of THFI (THF-insoluble component, mesogen) by performing the solvent extraction under conditions of

a mixing ratio (weight ratio) of THFI (THF insoluble component, mesogen):THFS (THF soluble component)=80:20 to 50:50; and

an extraction solvent, tetrahydrofuran (THF).

The mixing of the separated mesogen component with the isotropic pitch may be performed under conditions of

a mixing ratio of mesogen: isotropic pitch=30:70 to 70:30;

a mixing temperature of 200° C. to 400° C.; or

a mixing time of 5 minutes to 2 hours.

According to another aspect of the present disclosure, there is provided a high yield mesophase pitch manufactured by the method for manufacturing the high yield mesophase pitch.

A microstructure of the high yield mesophase pitch may have a form in which the anisotropic phase forms a flow domain of 75% to 100% and an isotropic matrix of 25% or less is dispersed.

In addition, the softening point of the high yield mesophase pitch may be 250° C. to 330° C.

In addition, the anisotropic content of the high yield mesophase pitch may be 75% to 100%.

In addition, the production yield of the high yield mesophase pitch may be 10% to 40%.

In addition, the high yield mesophase pitch may have a fiber cutting number of 2 times/400 rpm to 6 times/800 rpm depending on a winding speed of a winder with an outer diameter of 150 mm.

In addition, the high yield mesophase pitch may have L_{C} of 90 nm or more and La of 100 nm or more when graphitized at 2800° C. for 10 minutes.

According to the present disclosure, by providing the method for manufacturing the high yield mesophase pitch capable of obtaining high economic efficiency by increasing the production yield of the mesophase pitch by manufacturing the soluble mesophase pitch in which the lyotropic liquid crystalline material of anisotropic mesogen and the isotropic pitch acting as a solvent are mixed, due to the problem in an extremely low yield and low economic efficiency by performing excessive hydrogenation and removal of impurities, in order to maintain high spinnability of a fiber manufacturing process and high physical properties after heat treatment, the method for manufacturing the high yield mesophase pitch has excellent process stability and is economical.

In addition, by providing the high yield mesophase pitch that can be applied to high-priced carbon fiber production, low-cost carbon fiber production, artificial graphite anode materials, and the like, there is an advantage in various application ranges.

In addition, by providing the high yield mesophase pitch with a high spinnability and a high yield while maintaining whole anisotropy as a soluble mesophase pitch, which is a mixture of a lyotropic liquid crystalline material of anisotropic mesogen and isotropic pitch acting as a solvent, physical properties are excellent.

The effects of the present disclosure are not limited to the effects, but it should be understood to include all effects that can be deduced from the detailed description of the present disclosure or configurations of the present disclosure described in appended claims.

### BRIEF DESCRIPTION OF THE DRAWINGS

FIG. 1 is a process flowchart of a high yield mesophase pitch according to an embodiment of the present disclosure.

FIG. 2 is a polarized microscope image of a FCC-DO derived isotropic pitch according to an embodiment of the present disclosure.

FIG. 3 is a polarized microscope image of an isotropic coal-tar pitch (CTP) according to an embodiment of the present disclosure.

FIG. 4 is a polarized microscope image of a pressure-pretreated FCC-DO derived isotropic pitch according to an embodiment of the present disclosure.

FIG. 5 is a polarized microscope image of a hydrogenated FCC-DO derived anisotropic pitch according to an embodiment of the present disclosure.

FIG. 6 is a polarized microscope image of an anisotropic pitch obtained by mixing a mesogen component, THFI and a FCC-DO derived isotropic pitch at a weight ratio of 6:4 according to an embodiment of the present disclosure.

FIG. 7 is a polarized microscope image of an anisotropic pitch obtained by mixing a mesogen component, THFI and a CTP isotropic pitch at a weight ratio of 6:4 according to an embodiment of the present disclosure.

FIG. 8 is a polarized microscope image of an anisotropic pitch obtained by mixing a mesogen component, THFI and a pressure-pretreated FCC-DO derived isotropic pitch at a weight ratio of 6:4 according to an embodiment of the present disclosure.

FIG. 9 is a polarized microscope image of an anisotropic pitch obtained by mixing a mesogen component, THFI and a pressure-pretreated FCC-DO derived isotropic pitch at a weight ratio of 4:6 according to an embodiment of the present disclosure.

FIG. 10 is a schematic diagram of a melt spinning apparatus according to an embodiment of the present disclosure.

### DETAILED DESCRIPTION OF THE PREFERRED EMBODIMENT

Hereinafter, preferred embodiments of the present disclosure will be described in detail with reference to the accompanying drawings.

Advantages and features of the present disclosure, and methods for accomplishing the same will be more clearly understood from exemplary embodiments to be described below in detail with reference to the accompanying drawings.

However, the present disclosure is not limited to the following exemplary embodiments but may be implemented in various different forms. The exemplary embodiments are provided only to make description of the present disclosure complete and to fully provide the scope of the present disclosure to a person having ordinary skill in the art to which the present disclosure pertains with the category of the invention, and the present disclosure will be defined by the appended claims.

In the following description of the present disclosure, a detailed description of known arts related thereto will be omitted when it is determined to make the subject matter of the present disclosure rather unclear.

Hereinafter, the present disclosure will be described in detail.

### Manufacturing Method for High Yield Mesophase Pitch

The present disclosure provides a method for manufacturing a high yield mesophase pitch capable of obtaining high economic efficiency by increasing the production yield of a mesophase pitch by manufacturing a soluble mesophase pitch in which a lyotropic liquid crystalline material of anisotropic mesogen and an isotropic pitch acting as a solvent are mixed, unlike existing techniques that had a problem in an extremely low yield and low economic efficiency by performing excessive hydrogenation and removal of impurities, in order to maintain high spinnability of a fiber manufacturing process and high physical properties after heat treatment.

The method for manufacturing a high yield mesophase pitch comprising a mesogen component and an isotropic pitch, which exhibits liquid crystalline properties when the mesogen component is mixed with the isotropic pitch acting as a solvent and dissolved with each other, the manufacturing method comprising the steps of:

obtaining a hydrogenated raw material by hydrogenating heavy oil;

obtaining mesophase pitch having many mesogen components by mesophase formation of the obtained hydrogenated raw material;

obtaining flow-domained mesophase pitch by removing low boiling point components through thin film evaporation of the obtained mesophase pitch and concentrating the mesogen components;

separating only the mesogen components in the flow-domained mesophase pitch by solvent-extracting, filtering, and drying the flow-domained mesophase pitch; and

mixing the separated mesogen components with isotropic pitch.

In addition, the flow-domained mesophase pitch may be mesophase pitch in which a complete flow-domain is formed.

Here, a mesophase pitch production yield of the method for manufacturing the high yield mesophase pitch may be 10% to 40%.

At this time, the mesophase pitch production yield of the method for manufacturing the high yield mesophase pitch may be preferably 12% to 38%, more preferably 15% to 30%.

In addition, the heavy oil is heavy oil or residue oil derived from a crude oil refining process, and includes fluidized catalytic cracking-decant oil (FCC-DO), which is residue oil of a fluidized bed reactor, pyrolysis fuel oil (PFO) which is residue oil of a naphtha cracker, vacuum residue (VR) which is a residue of a vacuum distillation column, and the like. De-asphalted oil (DAO) and the like from which asphaltenes are removed from such heavy oil may be used as petroleum-based raw materials, and coal-tar, a by-product of a coal carbonization process may be used as coal-based raw materials.

In addition, the anisotropic mesogen may be a lyotropic liquid crystalline material.

In addition, the isotropic pitch may be prepared by the steps of:

preparing isotropic pitch by thermal-polymerizing the heavy oil at atmospheric pressure and pressurization;

controlling a softening point by thin film-evaporation of the isotropic pitch at a low temperature; and

separating the softening point-controlled isotropic pitch as a solvent component.

Here, the thin film evaporation may be thin-film evaporation (TFE) or thin-layer evaporation (TLE).

In this case, the softening point of the softening point-controlled isotropic pitch may be 120° C. to 200° C.

In addition, the hydrogenating may be performed under conditions of

a reaction temperature of 350° C. to 500° C.;

a reaction time of 10 minutes to 10 hours; or

a mixing ratio (weight ratio) of heavy oil:organic solvent=1:0.5 to 1:4.

Here, when the hydrogenating reaction temperature is less than 350° C., there is a problem that the hydrogenation efficiency may decrease, and when the hydrogenating reaction temperature is more than 500° C., there is a problem that economic efficiency may decrease.

In addition, when the hydrogenating reaction time is less than 10 minutes, there is a problem that the hydrogenation efficiency may be insignificant, and when the hydrogenating reaction time is more than 10 hours, there is a problem that economic efficiency may decrease.

In addition, when the mixing ratio (weight ratio) of heavy oil:organic solvent in the hydrogenating is less than 1:0.5, there is a problem that the hydrogenation efficiency may decrease, and when the mixing ratio (weight ratio) of heavy oil:organic solvent in the hydrogenating is more than 1:4, there is a problem that the manufacturing cost may increase.

In addition, the organic solvent may include a hydrogen-donating solvent including tetralin or tetrahydroquinoline. Here, the organic solvent is not limited thereto, and any hydrogen-donating solvent may be used.

In addition, the mesophase polymerization may be performed under conditions of

a reaction temperature of 370° C. to 500° C.;

a reaction time of 10 minutes to 10 hours; or

an inert gas flow rate of 100 ml/min/kg to 5000 ml/min/kg.

In this case, the mesophase polymerization is a thermal polymerization reaction.

In addition, the mesophase polymerization includes mesophase polymerization of a nitrogen fractionation method.

The mesophase polymerization of the nitrogen fractionation method is a thermal polymerization method for increasing the mesogen component by reducing the amount of the hydrogenation solvent and the hydrogenation treatment time under a nitrogen condition.

Here, when the reaction temperature of the mesophase polymerization is less than 370° C., there is a problem that the mesophase polymerization efficiency may decrease, and when the reaction temperature of the mesophase polymerization is more than 500° C., there is a problem that a coke may be formed due to rapid overreaction, and economic efficiency may be reduced due to an additional process for removing the coke component.

In addition, when the reaction time of the mesophase polymerization is less than 10 minutes, there is a problem that the mesophase polymerization efficiency may be insignificant, and when the reaction time of the mesophase polymerization is more than 10 hours, there is a problem that economic efficiency may decrease.

In addition, when the inert gas flow rate during the mesophase polymerization is less than 100 ml/min/kg, there is a problem that the mesophase polymerization efficiency may decrease, and when the inert gas flow rate during the mesophase polymerization is more than 5000 ml/min/kg, there is a problem that the manufacturing cost may increase.

In addition, the thin film evaporation may be performed under conditions of

a treatment temperature of 250° C. to 430° C.;

a treatment time of 5 minutes to 60 minutes; or

a pressure of 1 hPa to 100 hPa.

At this time, the thin film evaporation is a method of separating a desired material with 1 h purity and evaporation by forming a thin film, and is a method suitable for separating heat-sensitive materials or high-boiling-point materials.

Here, when the treatment temperature of the thin film evaporation is less than 250° C., there is a problem that the thin film evaporation efficiency may decrease, and when the treatment temperature of the thin film evaporation is more than 430° C., there is a problem that economic efficiency may decrease.

In addition, when the treatment time of the thin film evaporation is less than 5 minutes, there is a problem that the thin film evaporation efficiency may be insignificant, and when the treatment time of the thin film evaporation is more than 60 minutes, there is a problem that economic efficiency may decrease.

In addition, when the pressure during the thin film evaporation is more than 100 hPa there is a problem that the thin film evaporation efficiency may decrease, and when the pressure during the thin film evaporation is less than 1 hPa, there is a problem that manufacturing cost may increase.

Here, the flow-domained mesophase pitch obtained from the thin film evaporation may have a softening point of 240° C. to 350° C. or an anisotropic content of 90% to 100%.

At this time, the flow-domained mesophase pitch may have a form in which a 100% complete flow-domain is formed.

In addition, the solvent extraction may be performed under conditions of

a mixing ratio (weight ratio) of flow-domained mesophase pitch:solvent=1:2 to 1:40;

an extraction time of 5 minutes to 24 hours; or

an extraction solvent, tetrahydrofuran (THF).

Here, when the mixing ratio (weight ratio) of flow-domained mesophase pitch:solvent in the solvent extraction is less than 1:2, there is a problem that the solvent extraction efficiency may decrease, and when the mixing ratio (weight ratio) of flow-domained mesophase pitch:solvent is more than 1:40, there is a problem that the economic efficiency may decrease.

In addition, when the treatment time of the solvent extraction is less than 5 minutes, there is a problem that the solvent extraction efficiency may be insignificant, and when the treatment time of the solvent extraction is longer than 24 hours, there is a problem that the economic efficiency may decrease.

In addition, as the extraction solvent may use ethers containing diethyl ether and ketones containing MEK.

In addition, the solvent-extracted mesogen content may obtain 50% to 80% of a THF-insoluble component (THFI, mesogen) by performing the solvent extraction under conditions of

a mixing ratio (weight ratio) of THFI (THF insoluble component, mesogen):THFS (THF soluble component)=80:20 to 50:50; and

an extraction solvent, tetrahydrofuran (THF).

In this case, the THFI (THF insoluble component, mesogen) is a mesogen component insoluble in the THF solvent, and the THFS (THF soluble component) is an anisotropic pitch component dissolved in the THF solvent.

Here, when the mixing ratio (weight ratio) of THFI (THF insoluble component, mesogen):THFS (THF soluble component) in the solvent-extracted mesogen content is less than 80:20, there is a problem in that mesogen having reduced physical properties due to excessive polymerization or impurities may be generated. When the mixing ratio (weight ratio) of THFI (THF insoluble component, mesogen):THFS (THF soluble component) in the solvent-extracted mesogen content is more than 50:50, there is a problem in that economic efficiency may decrease.

In addition, as the extraction solvent may use ethers containing diethyl ether and ketones containing MEK.

In addition, the mixing of the separated mesogen component with the pressure-pretreated isotropic pitch as a solvent component may be performed under conditions of

a mixing ratio of mesogen:isotropic pitch=30:70 to 70:30;

a mixing temperature of 200° C. to 400° C.; or

a mixing time of 5 minutes to 2 hours.

Here, in the mixing of the separated mesogen component with the isotropic pitch, when the mixing ratio of mesogen:isotropic pitch is less than 30:70, there is a problem that the anisotropic pitch manufacturing efficiency may decrease, and when the mixing ratio of mesogen:isotropic pitch is less than 70:30, there is a problem that the economic efficiency may decrease.

In addition, in the mixing of the separated mesogen component with the isotropic pitch, when the mixing temperature is less than 200° C., there is a problem that the anisotropic pitch manufacturing efficiency may be insignificant, and when the mixing temperature is more than 400° C., there is a problem that the economic efficiency may decrease.

In addition, in the mixing of the separated mesogen component with the isotropic pitch, when the mixing time is less than 5 minutes, there is a problem that the anisotropic pitch manufacturing efficiency may decrease, and when the mixing time is more than 2 hours, there is a problem that the economic efficiency may decrease.

That is, the mesophase pitch may be prepared by mixing the separated mesogen component with the isotropic pitch as the solvent component.

In addition, the mesophase pitch may be prepared by mixing the separated mesogen component with the isotropic pitch as the solvent component and the anisotropic pitch dissolved in extraction solvent as a solvent component.

FIG. 1 is a process flowchart of a high yield mesophase pitch according to an embodiment of the present disclosure.

Referring to FIG. 1, a high yield isotropic pitch (S110) is manufactured by pressure-pretreating and thermally polymerizing heavy oil (S100) as a raw material, and then isotropic pitch (S120) with a controlled softening point as a solvent component may be manufactured through thin-film evaporation (TFE) or thin-layer evaporation (TLE).

In addition, a primary pitch (S140) may be manufactured by hydrogenating the heavy oil (S100) as the raw material to prepare a hydrogenation raw material (S130), and then performing thermal polymerization based on a nitrogen fractionation method.

Thereafter, an anisotropic pitch (S150) may be manufactured by performing thin-film evaporation (TFE) or thin-layer evaporation (TLE) on the primary pitch (S140).

Then, the anisotropic pitch (S150) solvent-extracted with a tetrahydrofuran (THF) solvent to be classified into THFS (S160), which is a solvent component soluble in THF, and THFI (S170) which is a mesogen component insoluble in THF.

Finally, the THFI (S170) as the mesogen component insoluble in THF is mixed with the isotropic pitch (S120) with the controlled-softening point as the solvent component and the THFS (S160) as the solvent component at a high temperature to manufacture high-yield and high-quality mesophase pitch (S200).

### High Yield Mesophase Pitch

The present disclosure provides a high yield mesophase pitch manufactured by the manufacturing method for the high yield mesophase pitch.

Particularly, the present disclosure provides a high yield mesophase pitch that can be applied to high-priced carbon fiber production, low-cost carbon fiber production, artificial graphite anode materials, and the like.

In addition, the present disclosure provides a high yield mesophase pitch with a high spinnability while maintaining whole anisotropy as soluble mesophase pitch, which is a mixture of a lyotropic liquid crystalline material of anisotropic mesogen and isotropic pitch acting as a solvent.

Further, the high yield mesophase pitch of the present disclosure exhibits a much higher production yield than existing mesophase pitches.

Here, the production yield of the high yield mesophase pitch may be 10% to 40%.

At this time, the production yield of the high yield mesophase pitch may be preferably 12% to 38%, more preferably 15% to 30%.

In addition, a microstructure of the high yield mesophase pitch may have a form in which the anisotropic phase forms a flow domain of 75% to 100% and an isotropic matrix of 25% or less is dispersed.

In addition, the softening point of the high yield mesophase pitch may be 250° C. to 330° C.

In addition, the anisotropic content of the high yield mesophase pitch may be 75% to 100%.

In addition, the high yield mesophase pitch may have a fiber cutting number of 2 times/400 rpm to 6 times/800 rpm depending on a winding speed of a winder with an outer diameter of 150 mm.

In addition, the high yield mesophase pitch may have L_{C} of 90 nm or more and La of 100 nm or more when graphitized at 2800° C. for 10 minutes.

Hereinafter, the present disclosure will be described in more detail with reference to Examples. However, the following Examples are for explaining the present disclosure in more detail, and the scope of the present disclosure is not limited by the following Examples. The following Examples can be appropriately modified and changed by those skilled in the art within the scope of the present disclosure.

### PREPARATION EXAMPLE

### Preparation Example 1

### Manufacture of FCC-DO Derived Isotropic Pitch

(1) Thermal Polymerization

100 g of a raw material, FCC-DO, was added to an autoclave reactor (volume of 150 ml). Thereafter, nitrogen gas was added at 200 ml/min, stirred at a rate of 100 rpm, and heated to 370° C. to 410° C. at a rate of 5° C./min, and thermal polymerization was performed by maintaining the corresponding temperature for 6 hours. Thereafter, the heating was stopped and a reaction product, a FCC-DO derived pitch, was recovered after waiting for until the internal temperature of the reactor dropped to room temperature.

2) Thin-Film Evaporation

The FCC--DO derived pitch obtained through thermal polymerization at atmospheric pressure was put into a rotary thin-film evaporator, heated to 370 to 410° C. under a reduced pressure of 10 hPa, then thin-film evaporated for 30 minutes to obtain FCC-DO derived isotropic pitch.

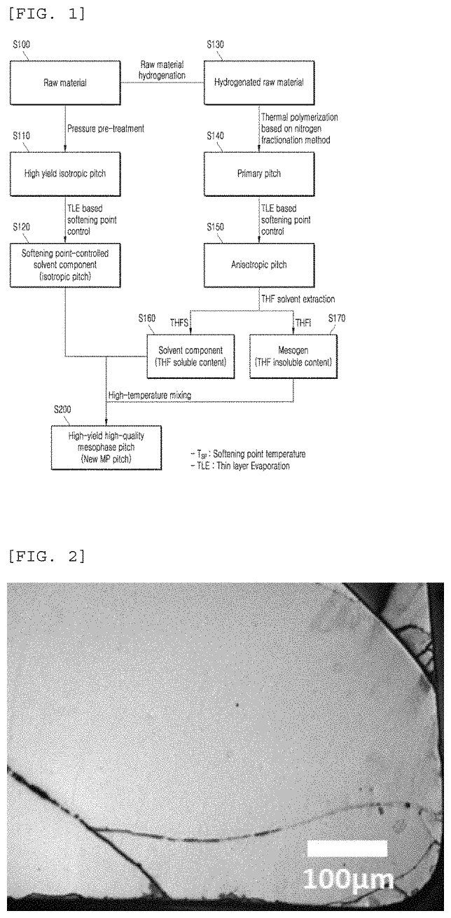

The softening point of the FCC-DO derived isotropic pitch obtained through thin film evaporation was 140° C., and the yield was 40.5%. As a result of observing the microstructure of the FCC-DO derived isotropic pitch through a polarized microscope, 100% of an isotropic structure was shown. The corresponding polarized microscope images were shown in FIG. 2.

### Preparation Example 2

### Manufacture of CTP Isotropic Pitch

(1) Thermal Polymerization

100 g of QI-free soft coal-tar pitch (CTP) as a raw material was added to an autoclave reactor (volume of 150 ml), Thereafter, argon was added at 200 ml/min, stirred at a rate of 100 rpm, and heated to 370° C. at a rate of 5° C./min, and thermal polymerization was performed by maintaining the corresponding temperature for 3 hours. Thereafter, the heating was stopped and a reaction product, a CTP thermal polymer, was recovered after waiting for until the internal temperature of the reactor dropped to room temperature.

2) Thin-Film Evaporation

The CTP thermal polymer obtained through thermal polymerization at atmospheric pressure was put into a rotary thin-film evaporator, and heated to 370° C. at a rate of 5° C./min under a reduced pressure of 10 hPa, and thin-film evaporated to maintain the corresponding temperature for 3 minutes to obtain CTP isotropic pitch.

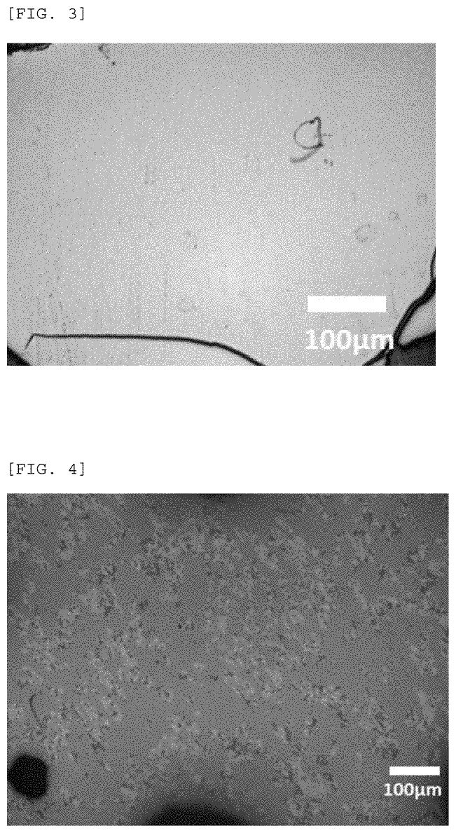

The softening point of the CTP isotropic pitch obtained through thin film evaporation was 140° C., and as a result of observing the microstructure of the pitch through a polarized microscope, 100% of an isotropic structure was shown. The corresponding polarized microscope images were shown in FIG. 3.

### EXAMPLES

### Example 1

### Manufacture of FCC-DO Derived Pressure-Pretreated Isotropic Pitch

1) Pressure Pre-Treatment

100 g of a raw material, FCC-DO, was added to an autoclave reactor (volume of 150 ml) and then completely sealed. Then, the raw material was stirred at a rate of 100 rpm, heated to 370° C. at a rate of 5° C./min and pressurized for 3 hours. Thereafter, the heating was stopped and a reaction product, a FCC-DO derived pressure-pretreated product, was recovered after waiting for until the internal temperature of the reactor dropped to room temperature.

(2) Thermal Polymerization

100 g of a FCC-DO derived pressure-pretreated product of step 1) of Example 1 was added to an autoclave reactor (volume of 150 ml). Then, the reactor was completely sealed. Thereafter, nitrogen gas was added in the reactor at 200 ml/min, stirred at a rate of 100 rpm, and heated to 415° C. at a rate of 5° C./and thermal polymerization was performed by maintaining the corresponding temperature for 6 hours. Then, the heating was stopped and a reaction product, a pressure-pretreated FCC-DO derived pitch, was recovered after waiting for until the internal temperature of the reactor dropped to room temperature.

3) Thin-Film Evaporation

The pressure-pretreated FCC-DO derived pitch obtained through thermal polymerization. was put into a rotary thin-film evaporator, heated to 370 to 410° C. under a reduced pressure of 10 hPa, then thin-film evaporated by maintaining the temperature for 30 minutes to obtain pressure-pretreated FCC-DO derived isotropic pitch.

The softening point of the pressure-pretreated FCC-DO derived isotropic pitch obtained through thin film evaporation was 140° C. and the yield was 56.4%. As a result of observing the microstructure of the pressure-pretreated FCC-DC) derived isotropic pitch through a polarized microscope, 100% of an isotropic structure was shown. The corresponding polarized microscope images were shown in FIG. 4.

### Example 2

### Manufacture of High Yield Mesophase Pitch

1) Hydrogenation

50 g of FCC-DO and 50 g of tetralin were added to an autoclave reactor (volume of 150 ml) and then completely sealed. Then, the mixture was stirred at a rate of 100 rpm, heated to 170° C. at a rate of 10° C./min and the hydrogenation was performed by maintaining the corresponding temperature for 1 hour. Thereafter, the heating was stopped and a reaction product, hydride of FCC-DO and tetralin, was recovered after waiting for until the internal temperature of the reactor dropped to room temperature.

In order to separate tetralin from the reaction product, the hydride of FCC-DO and tetralin, the hydride of FCC-DO and tetralin was put in a rotary evaporator and treated for 1 hour at a temperature of 150° C. Through this, tetralin was removed and 50 g of hydrogenated FCC-DO was obtained.

(2) Thermal Polymerization

Tetralin used in step 1) of Example 2 was removed and 100 g of hydrogenated FCC-DO was added in an autoclave reactor (volume of 150 ml), and then nitrogen gas flowed at a rate of 200 ml/min. The autoclave reactor was stirred at a rate of 100 rpm, heated to 415° C. at a rate of 5° C./min and the thermal polymerization was performed by maintaining the corresponding temperature for 6 hour. Thereafter, the heating was stopped and a reaction product, a hydrogenated FCC-DO derived pitch, was recovered by stopping nitrogen gas and stirring after waiting for until the internal temperature of the reactor dropped to room temperature.

3) Thin Film Evaporation

The hydrogenated FCC-DO derived pitch obtained through thermal polymerization was put into a rotary thin film evaporator, heated to 370 to 410° C. under a reduced pressure of 10 hPa, and thin film-evaporated by maintaining the corresponding temperature for 30 minutes to obtain the hydrogenated FCC-DO derived anisotropic pitch.

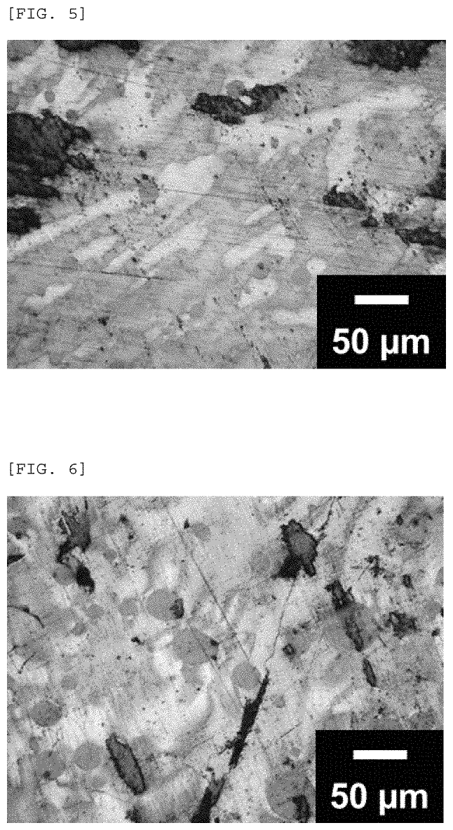

The softening point of the hydrogenated FCC-DO derived anisotropic pitch obtained through thin film evaporation was 254° C., and the yield was 15.6%, and as a result of observing the microstructure through a polarized microscope, about 95% of an anisotropic structure was shown. The corresponding polarized microscope image was shown in FIG. 5.

4) Solvent Extraction

To separate the mesogen component, the hydrogenated FCC-DO derived anisotropic pitch of step 3) of Example 2 was mixed with an organic solvent, THF (tetrahydrofuran) in a weight ratio of 1:9, and then stirred for 24 hours at a temperature of 50° C.

Thereafter, a component (insoluble content) that were not dissolved in the solvent was filtered through reduced pressure filtration, and the insoluble content was recovered and then dried in a convection oven at 60° C. for 12 hours. The dried insoluble content corresponded to the mesogen component and was named THFI.

In addition, the anisotropic pitch component dissolved in the solvent THF was named as THFS.

The THFI:THFS ratio obtained in step 4) was 65:35.

### Example 3

### Manufacture of High Yield Mesophase Pitch

The THFI as the mesogen component obtained in Example 2 and the FCC-DO derived isotropic pitch obtained in Preparation Example 1 were mixed at a weight ratio of 6:4, heated to a temperature of 350° C. at a heating rate of 5° C./min and then stirred for 30 minutes to manufacture mesophase pitch with a high yield.

The softening point of the mesophase pitch obtained through mixing was 255° C., and the yield was 21.4%. As a result of observing through a polarized microscope, the mesophase pitch contained 84% of the anisotropic structure and was uniformly dispersed without aggregation in the form of globules. The corresponding polarized microscope image was shown in FIG. 6.

### Example 4

### Manufacture of High Yield Mesophase Pitch

The THFI as the mesogen component obtained in Example 2 and the CTP isotropic pitch obtained in Preparation Example 2 were mixed at a weight ratio of 6:4, heated to a temperature of 350° C. at a heating rate of 5° C./min and then stirred for 30 minutes to manufacture mesophase pitch with a high yield.

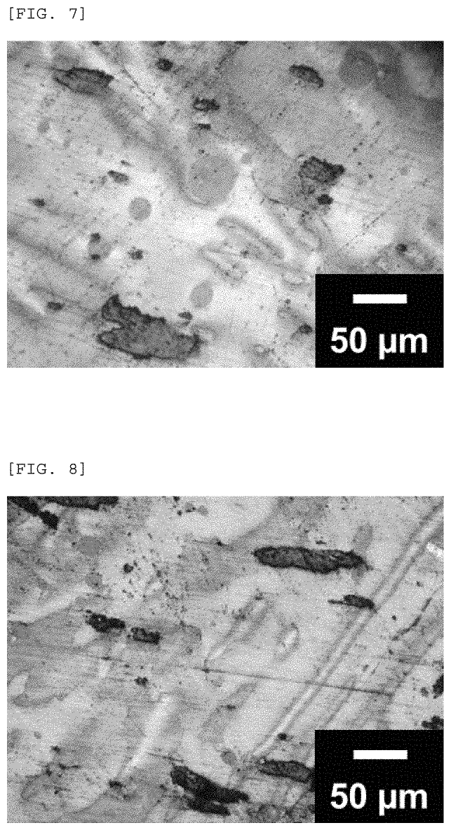

The softening point of the mesophase pitch obtained through mixing was 280° C., and the yield was 22.1%. As a result of observing through a polarized microscope, the mesophase pitch contained 90% of the anisotropic structure and was uniformly dispersed without aggregation in the form of globules. The corresponding polarized microscope image was shown in FIG. 7.

### Example 5

### Manufacture of High Yield Mesophase Pitch

The THFI as the mesogen component obtained in Example 2 and the pressure-pretreated FCC-DO derived isotropic pitch obtained in Example 1 were mixed at a weight ratio of 6:4, heated to a temperature of 350° C. at a heating rate of 5° C./min and then stirred for 30 minutes to manufacture mesophase pitch with a high yield.

The softening point of the mesophase pitch obtained through mixing was 276° C., and the yield was 27.5%. As a result of observing through a polarized microscope, the mesophase pitch contained 94% of the anisotropic structure and was uniformly dispersed without aggregation in the form of globules. The corresponding polarized microscope image was shown in FIG. 8.

### Example 6

### Manufacture of High Yield Mesophase Pitch

The THFI as the mesogen component obtained in Example 2 and the pressure-pretreated FCC-DO derived isotropic pitch obtained in Example 1 were mixed at a weight ratio of 4:6, heated to a temperature of 350° C. at a heating rate of 5° C./min and then stirred for 30 minutes to manufacture mesophase pitch with a high yield.

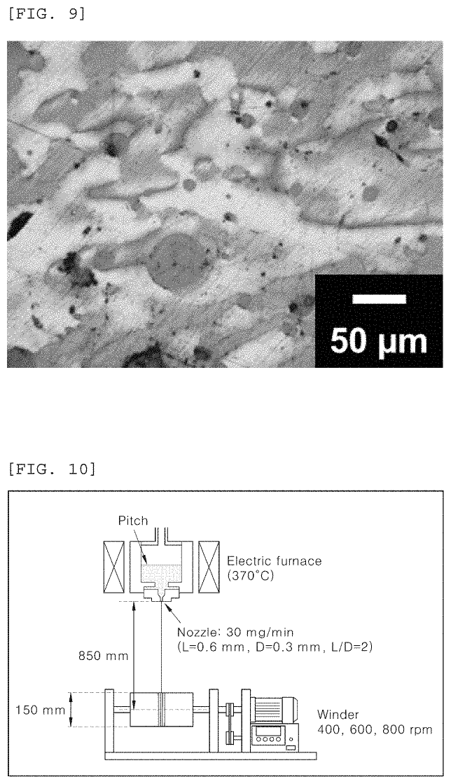

The softening point of the mesophase pitch obtained through mixing was 266° C., and the yield was 36.2%. As a result of observing through a polarized microscope, the mesophase pitch contained 75% of the anisotropic structure and was uniformly dispersed without aggregation in the form of globules. The corresponding polarized microscope image was shown in FIG. 9.

### Example 7

### Evaluation of Spinnability

1) Melt Spinning

The spinnability of the mesophase pitch for spinning obtained through Example 5 was evaluated.

Mesophase pitch prepared by mixing mesogen and the pressure-pretreated FCC-DO derived isotropic pitch as the solvent component was added into a spinning barrel at 6:4 and heated at a temperature of 50 to 70° C. higher than the softening point at 5° C./min, and melt spinning performance was tested. As a used nozzle, a nozzle having a diameter of 0.30 mm and a length. of 0.60 mm was used, and the spinnability was evaluated by winding using a winder having a diameter of 150 mm in a spinline of about 850 mm. The corresponding melt spinning apparatus was shown in FIG. 10.

The spinning apparatus of FIG. 10 is a typical melt spinning test apparatus, and the dried pitch is pulverized into a barrel in a batch state, and heated until the pitch is in a molten state while stabilizing in a nitrogen atmosphere. Thereafter, when the molten pitch is manufactured in the form of fiber phase through an orifice (100 to 300 μm orifice) of the nozzle a constant pressure of 50 to 300 psi, the spinning apparatus is a pitch melt spinning apparatus of manufacturing a pitch fiber by winding on a winder at the bottom of the spin line according to a certain number of rotation.

According to a spinning environment, as shown in FIG. 10, the pitch is put into the barrel in a batch manner and spinning is performed, or pitch spinning is performed in a continuous manner using an extruder type. For the nozzle, a nozzle having 1 to 50 holes for experiment and 500 to 2,000 holes in a pilot scale is used, and an orifice of the nozzle is 75 to 300 μm and controlled to be a diameter of the spun pitch fiber of 8 to 15 μm by combining variables such as L/D of about 2 to 6, a temperature of overall melt pitch, a pipe diameter and L/D of the orifice, a linear velocity of the winder, and the like.

The pitch fibers are finally manufactured into carbon fibers or graphite fibers having a diameter of 6 to 12 μm through post-stage processes, such as stabilization, carbonization, and graphitization.

2) Evaluation of Spinnability

Melt spinning was evaluating by winding fibers on a winder having OD 150 mm in step 1) of Example 7. When winding the winder at a rate of 400 rpm, about twice of fiber breakage was observed for about 3 minutes of the spinning trial, when winding the winder at rate of 600 rpm, about 4 times of fiber breakage was observed for about 3 minutes of the spinning trial, and when winding the winder at a rate of 800 rpm, about 6 times of fiber breakage was observed for about 3 minutes of the spinning trial.

As can be seen in the result of step 2) of Example 7, the mesophase pitch manufactured according to the present disclosure not only exhibits a higher manufacturing yield than existing mesophase pitches, but also exhibits high spinnability even when manufactured into fibers.

### Example 8

### Evaluation of Molecular Stackability and Graphitization Property

1) Evaluation of Stackability

The molecular stackability of the mesophase pitches prepared in Examples 3, 4, and 5 was evaluated using XRD at room temperature, and the results were shown in Table 1 below.

TABLE 1

| | | | Number of |
|---|---|---|---|
| | d₀₀₂ [nm] | L_{C} [nm] | sheet [—] |
| High yield mesophase | 0.3539 | 2.78 | 8.87 |
| pitch of Example 3 | | | |
| High yield mesophase | 0.3539 | 3.27 | 10.24 |
| pitch of Example 4 | | | |
| High yield mesophase | 0.3529 | 3.17 | 9.99 |
| pitch of Example 5 | | | |

Although the manufactured mesophase pitch exhibited a relatively low number of stacks unique to petroleum-based, it was found that on average, the stackability of 8 or more layers was exhibited.

2) Evaluation of Graphitic Property

The graphitic properties of mesophase pitch graphitized at 2800° C. with the pitches prepared in Examples 3, 4, and 5 were evaluated using XRD at room temperature, and the results were shown in Table 2 below.

TABLE 2

| | d₀₀₂ [nm] | L_{C} [nm] | Lₐ [nm] |
|---|---|---|---|
| High yield mesophase | 0.3365 | 95.38 | 100 or |
| pitch of Example 3 | | | more |
| High yield mesophase | 0.3362 | 115.31 | 100 or |
| pitch of Example 4 | | | more |
| High yield mesophase | 0.3365 | 91.87 | 100 or |
| pitch of Example 5 | | | more |

Here, the graphitic properties of all the pitches were d₀₀₂ of 0.337 nm or less, L_{C} of 91 to 100 nm or more, and Lₐ(110) of 100 nm or more, and a high graphitic property as a bi-graphitizable material unique to mesophase pitch was exhibited.

As described above, the specific embodiments of the manufacturing method for the high yield mesophase pitch and the high yield mesophase pitch manufactured therefrom according to the present disclosure have been described, but it will be apparent that various modifications can be made without departing from the scope of the present disclosure.

Therefore, the scope of the present disclosure should not be limited to the embodiments and should be defined by the appended claims and equivalents to the appended claims.

In other words, the embodiments described above are illustrative in all aspects and should be understood as not being restrictive, and the scope of the present disclosure is represented by appended claims to be described below rather than the detailed description, and it is to be interpreted at the meaning and scope of the appended claims and all changed or modified forms derived from the equivalents thereof are included within the scope of the present disclosure.

What is claimed is:

1. A method for manufacturing a high yield mesophase pitch comprising a mesogen component and an isotropic pitch, which exhibits liquid crystalline properties when the mesogen component is mixed with the isotropic pitch acting as a solvent and dissolved with each other, the manufacturing method comprising the steps of:
obtaining a hydrogenated raw material by hydrogenating heavy oil;
obtaining mesophase pitch having many mesogen components by mesophase formation of the obtained hydrogenated raw material;
obtaining flow-domained mesophase pitch by removing low boiling point components through thin film evaporation of the obtained mesophase pitch and concentrating the mesogen components;
separating only the mesogen components in the flow-domained mesophase pitch by solvent-extracting, filtering, and drying the flow-domained mesophase pitch; and
mixing the separated mesogen components with isotropic pitch.

2. The manufacturing method for the high yield mesophase pitch of claim 1, wherein a mesophase pitch production yield of the method for manufacturing the high yield mesophase pitch is 10% to 40%.

3. The manufacturing method for the high yield mesophase pitch of claim 1, wherein the isotropic pitch is prepared by the steps of:
preparing isotropic pitch by thermal-polymerization of the heavy oil at atmospheric pressure and pressurization;
controlling a softening point by thin film-evaporation of the isotropic pitch at a low temperature; and
separating the softening point -controlled isotropic pitch as a solvent component.

4. The manufacturing method for the high yield mesophase pitch of claim 1, wherein the hydrogenating is performed under conditions of
a reaction temperature of 350° C. to 500° C.;
a reaction time of 10 minutes to 10 hours; or
a mixing ratio (weight ratio) of heavy oil:organic solvent=1:0.5 to 1:4.

5. The manufacturing method for the high yield mesophase pitch of claim 4, wherein the organic solvent includes a hydrogen-donating solvent including tetralin or tetrahydroquinoline.

6. The manufacturing method for the high yield mesophase pitch of claim 1, wherein the mesophase pitch formation is performed under conditions of
a reaction temperature of 370° C. to 500° C.;
a reaction time of 10 minutes to 10 hours; or
an inert gas flow rate of 100 ml/min/kg to 5000 ml/min/kg.

7. The manufacturing method for the high yield mesophase pitch of claim 1, wherein the thin film evaporation is performed under conditions of
a treatment temperature of 250° C. to 430° C.;
a treatment time of 5 minutes to 60 minutes; or
a pressure of 1 hPa to 100 hPa.

8. The manufacturing method for the high yield mesophase pitch of claim 1, wherein the flow-domained mesophase pitch obtained from the thin film evaporation has a softening point of 240° C. to 350° C. or an anisotropic content of 90% to 100%.

9. The manufacturing method for the high yield mesophase pitch of claim 1, wherein the solvent extraction is performed under conditions of
a mixing ratio (weight ratio) of flow-domained mesophase pitch:solvent=1:2 to 1:40;
an extraction time of 5 minutes to 24 hours; or
an extraction solvent, tetrahydrofuran (THF).

10. The manufacturing method for the high yield mesophase pitch of claim 1, wherein the solvent-extracted mesogen content obtains 50% to 80% of THFI (THF-insoluble component, mesogen) by performing the solvent extraction under conditions of
a mixing ratio (weight ratio) of THFI (THF insoluble component, mesogen):THFS (THF soluble component)=80:20 to 50:50; and
an extraction solvent, tetrahydrofuran (THF).

11. The manufacturing method for the high yield mesophase pitch of claim 1, wherein the mixing of the separated mesogen component with the isotropic pitch is performed under conditions of
a mixing ratio of mesogen: isotropic pitch=30:70 to 70:30;
a mixing temperature of 200° C. to 400° C.; or
a mixing time of 5 minutes to 2 hours.

12. High yield mesophase pitch manufactured by the method of claim 1.

13. The high yield mesophase pitch of claim 12, wherein a microstructure of the high yield mesophase pitch has a form in which the anisotropic phase forms a flow domain of 75% to 100% and an isotropic matrix of 25% or less is dispersed.

14. The high yield mesophase pitch of claim 12. wherein the softening point of the high yield mesophase pitch is 250° C. to 330° C.

15. The high yield mesophase pitch of claim 12, wherein the anisotropic content of the high yield mesophase pitch is 75% to 100%.

16. The high yield mesophase pitch of claim 12, wherein the production yield of the high yield mesophase pitch is 10% to 40%.

17. The high yield mesophase pitch of claim 12, wherein the high yield mesophase pitch has a fiber cutting number of 2 times/400 rpm to 6 times/800 rpm depending on a winding speed of a winder with an outer diameter of 150 mm.

18. The high yield mesophase pitch of claim 12, wherein the high yield mesophase pitch has L_{C} of 90 nm or more and La of 100 nm or more when graphitized at 2800° C. for 10 minutes.
